(19) United States
(12) Patent Application Publication
(10) Pub. No.: US 2020/0130579 A1
(43) Pub. Date: Apr. 30, 2020

(54) Truck Parking Safety System

(71) Applicant: Jose Mejia, Dalton, GA (US)

(72) Inventor: Jose Mejia, Dalton, GA (US)

(21) Appl. No.: 16/176,046

(22) Filed: Oct. 31, 2018

(51) Int. Cl. B60Q 9/00; B60T 17/22; B60Q 5/00; B60Q 1/44; B60Q 1/48

(52) U.S. Cl. CPC B60Q 9/002; B60T 17/22; B60T 1/02; B60Q 1/44; B60Q 1/486; B60Q 5/005

(57) ABSTRACT

A truck parking safety system for alerting drivers to unsafe parking practices includes a speaker and a plurality of lights that are in operational communication with a microprocessor. The microprocessor is in operational communication with a sensor array that is configured to detect truck brake and trailer brake engagement as well as driver's door position. When the driver's side door is open and the parking brakes for either or both the truck and the trailer brakes are not engaged the microprocessor activates the speaker and the plurality of lights to create an audio-visual alarm. The microprocessor ceases the audio-visual alarm when the sensor array detects that the parking brake and the trailer brake are each engaged.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98

The disclosure and prior art relates to parking safety systems and more particularly pertains to a new parking safety system for alerting drivers to unsafe parking practices.

### BRIEF SUMMARY OF THE INVENTION

An embodiment of the disclosure meets the needs presented above by generally comprising a housing having a front side separated from a rear side, a left side separated from a right side, and a bottom side separated from a top side. The rear side, the left side, the right side, and the bottom side form a cavity within the housing. The front side of the housing has a speaker grille extending through to the cavity. A plurality of lights is coupled to the front side of the housing. A speaker is coupled to the housing within the cavity adjacent the speaker grille of the front side. A tone generator that is in operational communication with the speaker is coupled within the cavity of the housing. A microprocessor is coupled within the cavity of the housing and is in operational communication with the tone generator. A sensor array is in operational communication with the microprocessor and is configured to be in operational communication with a parking brake of a truck, a driver's door of the truck, and a trailer brake of a trailer. The sensor array detects the driver's side door status as open or closed, the parking brake engagement and disengagement, and the trailer brake engagement and disengagement. The microprocessor generates an audio-visual alarm through the plurality of lights and the speaker when the sensor array detects that the parking brake or the trailer brake is disengaged and the driver's door is in the open position. The microprocessor ceases the audio-visual alarm when the sensor array detects that the parking brake and the trailer brake are each engaged.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric view of the truck parking safety system according to an embodiment of the disclosure.

FIG. 2 is a cross-sectional view of an embodiment of the disclosure along line 2-2 of FIG. 1.

FIG. 3 is a block diagram view of an embodiment of the disclosure.

### DETAILED DESCRIPTION OF THE INVENTION

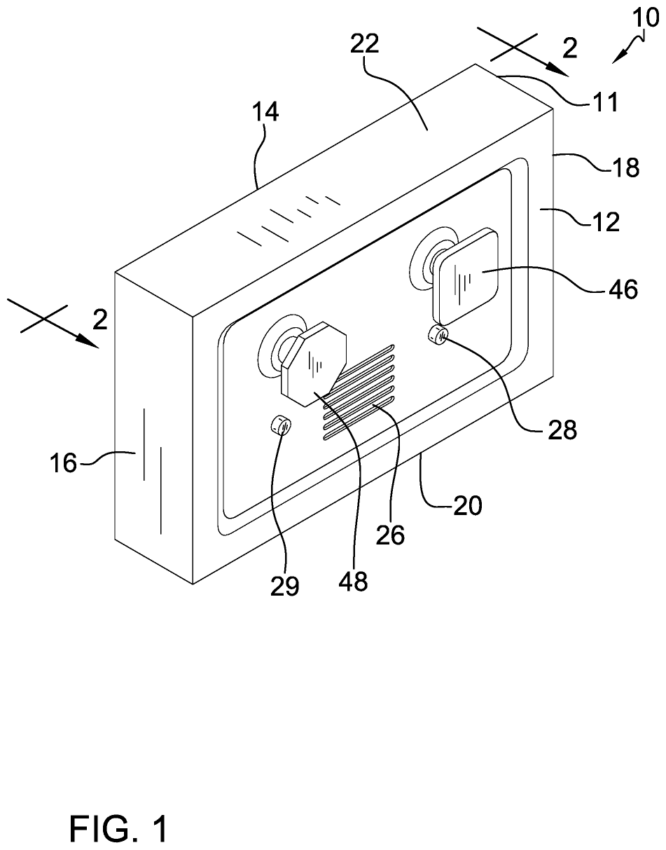

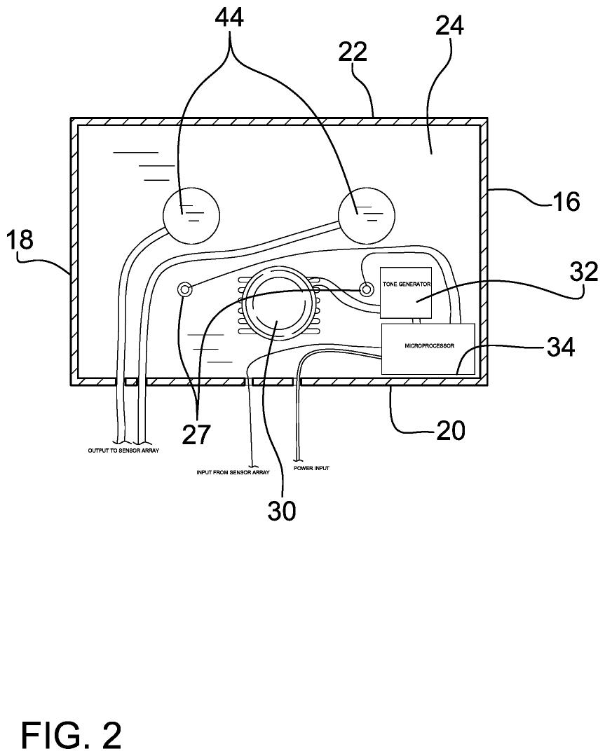

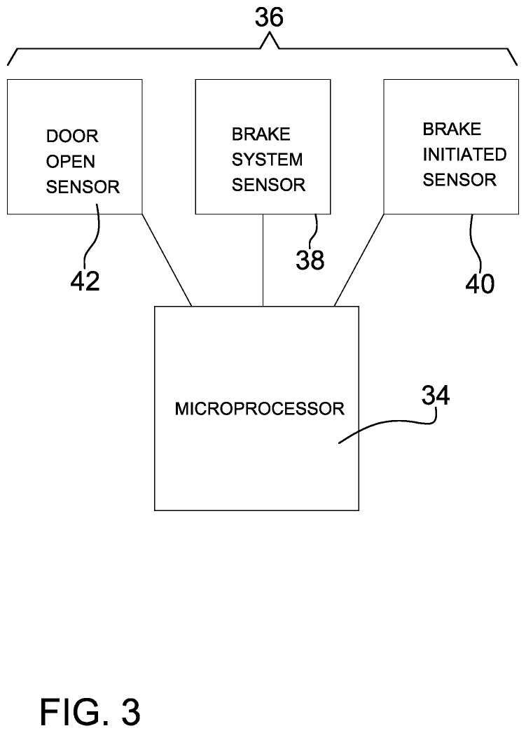

With reference now to the drawings, and in particular to FIGS. 1 through 3 thereof, a new parking safety system embodying the principles and concepts of an embodiment of the disclosure and generally designated by the reference numeral 10 will be described.

As best illustrated in FIGS. 1 through 3, the truck parking safety system 10 generally comprises a housing 11 having a front side 12 separated from a rear side 14, a left side 16 separated from a right side 18, and a bottom side 20 separated from a top side 22. The rear side 14, the left side 16, the right side 18, the bottom side 20 and the top side 22 form a cavity 24 within the housing 11. The front side 12 of the housing has a speaker grille 26 extending through to the cavity 24. A plurality of lights 27 is coupled through the front side 12 the housing and may comprise a truck light 28 and a trailer light 29. A speaker 30 is coupled within the cavity 24 of the housing. A tone generator 32 is coupled within the cavity 24 of the housing and is in operational communication with the speaker 30. A microprocessor 34 is coupled within the cavity 24 of the housing and is in operational communication with the tone generator 32.

A sensor array 36 is in operational communication with the microprocessor 34 and is configured to be in operational communication with a parking brake of a truck, a driver's door of the truck, and a trailer brake of a trailer. The sensor array 36 may comprise a brake system sensor 38, a brake initiated sensor 40, and a door ajar sensor 42. The brake system sensor 38 is configured to detect parking brake disengagement and trailer brake disengagement, the brake initiated sensor 40 detects parking brake and trailer brake engagement, and the door ajar sensor 42 detects driver's door position. The driver's door has a closed position and an alternate open position.

A pair of brake controls 44 may be coupled to the housing and comprises a square truck brake control 46 and an octagonal trailer brake control 48. The truck brake control 46 is coupled to the front side 12 of the housing adjacent the truck light 28 and the trailer brake control 48 is coupled to the front side 12 of the housing adjacent the trailer light 29. The pair of brake controls 44 is in operational communication with the sensor array 36. The truck brake control 46 is configured to engage and alternatively disengage the parking brake and the trailer brake control 48 is configured to engage and alternatively disengage the trailer brake.

In use, the microprocessor 34 generates an audio-visual alarm through the plurality of lights 27 and the speaker 30 when the sensor array 36 detects that the parking brake or the trailer brake is disengaged and the driver's door is in the open position. The truck light 28 illuminates when the brake system sensor 38 detects parking brake disengagement and the trailer light illuminates when the brake system sensor 38 detects trailer brake disengagement. The microprocessor 34 ceases the audio-visual alarm when the brake initiated sensor 40 detects that the parking brake and the trailer brake are each engaged.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A truck parking safety system comprising:
a housing having a front side separated from a rear side, a left side separated from a right side, and a bottom side separated from a top side, the front side, the rear side, the left side, the right side, and the bottom side forming a cavity, the front side of the housing having a speaker grille extending through to the cavity;
a plurality of lights coupled to the housing, the plurality of lights being coupled through the front side of the housing;
a speaker coupled to the housing, the speaker being coupled within the cavity adjacent the speaker grille of the front side;
a tone generator coupled to the housing, the tone generator being coupled within the cavity, the tone generator being in operational communication with the speaker;
a microprocessor coupled to the housing, the microprocessor being coupled within the cavity, the microprocessor being in operational communication with the tone generator; and
a sensor array, the sensor array being in operational communication with the microprocessor, the sensor array being configured to be in operational communication with a parking brake of a truck, a driver's door of the truck, and a trailer brake of a trailer, the driver's door having a closed position and an alternate open position, the sensor array detecting parking brake and trailer brake disengagement, parking brake and trailer brake engagement, and driver's door position;
wherein the microprocessor generates an audio-visual alarm through the plurality of lights and the speaker when the sensor array detects that the parking brake or the trailer brake is disengaged and the driver's door is in the open position, the microprocessor ceasing the audio-visual alarm when the sensor array detects that the parking brake and the trailer brake are each engaged.

2. The truck parking safety system of claim 1 further comprising the sensor array comprising a brake system sensor, a brake initiated sensor, and a door ajar sensor, the brake system sensor being configured to detect parking brake disengagement and trailer brake disengagement, the brake initiated sensor detecting parking brake and trailer brake engagement, and the door ajar sensor detecting driver's door position.

3. The truck parking safety system of claim 2, further comprising a pair of brake controls coupled to the front side of the housing, the pair of brake controls comprising a truck brake control and a trailer brake control, the pair of brake controls being in operational communication with the sensor array, the truck brake control being configured to engage and alternatively disengage the parking brake, the trailer brake control being configured to engage and alternatively disengage the trailer brake.

4. The truck parking safety system of claim 3 further comprising the trailer brake control being octagonal and the parking brake control being square.

5. The truck parking safety system of claim 3 further comprising the plurality of lights being a pair of lights comprising a truck light and a trailer light, the truck light being disposed adjacent the truck brake control and the trailer light being disposed adjacent the trailer brake control, the truck light illuminating when the brake system sensor detects parking brake disengagement and the trailer light illuminating when the brake system sensor detects trailer brake disengagement.

6. A truck parking safety system comprising:
a housing having a front side separated from a rear side, a left side separated from a right side, and a bottom side separated from a top side, the front side, the rear side, the left side, the right side, and the bottom side forming a cavity, the front side of the housing having a speaker grille extending through to the cavity;
a plurality of lights coupled to the housing, the plurality of lights comprising a pair of lights being coupled through the front side of the housing, the pair of lights comprising a truck light and a trailer light;
a speaker coupled to the housing, the speaker being coupled within the cavity adjacent the speaker grille of the front side;
a tone generator coupled to the housing, the tone generator being coupled within the cavity, the tone generator being in operational communication with the speaker;
a microprocessor coupled to the housing, the microprocessor being coupled within the cavity, the microprocessor being in operational communication with the tone generator;
a sensor array, the sensor array being in operational communication with the microprocessor, the sensor array being configured to be in operational communication with a parking brake of a truck, a driver's door of the truck, and a trailer brake of a trailer, the driver's door having a closed position and an alternate open position, the sensor array comprising a brake system sensor, a brake initiated sensor, and a door ajar sensor, the brake system sensor being configured to detect parking brake disengagement and trailer brake disengagement, the brake initiated sensor detecting parking brake and trailer brake engagement, and the door ajar sensor detecting driver's door position; and
a pair of brake controls coupled to the housing, the pair of brake controls comprising an square truck brake control and an octagonal trailer brake control each being coupled to the front side of the housing, the truck brake control being coupled adjacent the truck light and the trailer brake control being coupled adjacent the trailer light, the pair of brake controls being in operational communication with the sensor array, the truck brake control being configured to engage and alternatively disengage the parking brake, the trailer brake control being configured to engage and alternatively disengage the trailer brake;
wherein the microprocessor generates an audio-visual alarm through the plurality of lights and the speaker when the sensor array detects that the parking brake or the trailer brake is disengaged and the driver's door is in the open position, the truck light illuminating when the brake system sensor detects parking brake disengagement and the trailer light illuminating when the brake system sensor detects trailer brake disengagement, the microprocessor ceasing the audio-visual alarm when the sensor array detects that the parking brake and the trailer brake are each engaged.
